(19) United States
(12) Patent Application Publication
(10) Pub. No.: US 2026/0006294 A1
(43) Pub. Date: Jan. 1, 2026

(54) SYSTEM AND METHOD FOR SERVICE PROVIDER CLIENT SERVICE CONSULATION AND MANAGEMENT

(71) Applicants: Arisa Ortiz, San Diego, CA (US); Michael Barzman, San Diego, CA (US)

(72) Inventors: Arisa Ortiz, San Diego, CA (US); Michael Barzman, San Diego, CA (US)

(21) Appl. No.: 18/757,375

(22) Filed: Jun. 27, 2024

(51) Int. Cl. H04N 21/472; G06F 3/0482; G06Q 50/10; H04N 21/854

(52) U.S. Cl. CPC H04N 21/47202; G06F 3/0482; H04N 21/854; G06Q 50/10

(57) ABSTRACT

Embodiments of architecture, systems, and methods that enable service providers to manage and provide parameters and risks of/pre-consultation for their services to clients via interfaces including videos.

### TECHNICAL FIELD

The present invention relates generally to the systems for providing information to clients about services of a service provider.

### BACKGROUND INFORMATION

Service providers may desire to present information about their services to a client prior to providing the services or having an initial discussion/consultation/meeting, the present invention provides systems and methods for clients/potential clients to learn about available services and associated risks from service provider.

### SUMMARY OF THE INVENTION

The invention includes a computer-implemented service provider client consultation and management method. The method includes enabling a service provider to create a plurality of services to obtain a plurality of parameters for each service of the plurality of services, obtain at least one risk factor for each service of the plurality of services, form a video based on the plurality of parameters and at the least one risk factor for each service of the plurality of services, and store the plurality of parameters, at least one risk factor, and formed video for each service of the plurality of services in a service database. The method may also include enabling a client to be presented with at least one service of the plurality of services to provide a plurality of selectable parameters based on at least two of the plurality of services, to receive at least one selection of the plurality of selectable parameters, to provide at least one selectable service including associated at the least one risk factor of the plurality of services based on the received at least one selection of the plurality of selectable parameters, to receive at least one selection of the plurality services, and to provide the video associated with received at least one selection of the plurality services.

The invention also includes forming a video based on the plurality of parameters and at the least one risk factor for each service of the plurality of services via artificial intelligence. The invention may also include forming a video based on the plurality of parameters and at the least one risk factor for each service of the plurality of services via artificial intelligence (AI) where the video includes at least one AI generated actor that describes each service based on its plurality of parameters and at least one risk factor. The invention may further include enabling the service provider to view the AI generated video and elect to have the video regenerated by AI based on the plurality of parameters and at the least one risk factor for each service of the plurality of services.

In an embodiment, the method may include obtaining a plurality of parameters and at least one description for each service of the plurality of services and forming a video based on the plurality of parameters, the at one least description, and at the least one risk factor for each service of the plurality of services via artificial intelligence. The invention may also include obtaining a plurality of parameters and at least one description for each service of the plurality of services and forming a video based on the plurality of parameters, the at least one description, and at the least one risk factor for each service of the plurality of services via artificial intelligence (AI) where the video includes at least one AI generated actor that describes each service based on its plurality of parameters, at least one description and at least one risk factor.

The invention may also include obtaining a plurality of parameters, at least one description, at least one risk factor, and at least one other factor for each service of the plurality of services and forming a video based on the plurality of parameters, the at least one description, the at least one risk factor, and the at least one other factor for each service of the plurality of services via artificial intelligence. The invention may also include obtaining a plurality of parameters, at least one description, at least one risk factor, and at least one other factor for each service of the plurality of services and forming a video based on the plurality of parameters, the at least one description, the at least one risk factor, and the at least one other factor for each service of the plurality of services via artificial intelligence (AI) where the video includes at least one AI generated actor that describes each service based on its plurality of parameters, at least one description and at least one risk factor.

The invention may also enable a client the ability to schedule the at least one selection of the plurality services. The invention may also enable a client the ability to schedule the at least one selection of the plurality services after the client has been provided with the video associated with received at least one selection of the plurality services. The invention may also enable a client the ability to schedule the at least one selection of the plurality services after the client has reviewed the video associated with received at least one selection of the plurality services. The invention may also enable a client the ability to schedule the at least one selection of the plurality services after the client has reviewed the entire video associated with received at least one selection of the plurality services.

The invention may further forward a notice to a service provider when a client schedules the at least one selection of the plurality services. In an embodiment, the service provider is a medical provider and the client is one of a patient and a potential patient. In an embodiment, the plurality of services is a plurality of medical treatments. In an embodiment, the service provider is a medical provider and the client is one of a patient and a potential patient. In an embodiment, the service provider is a dermatologist. In an embodiment, the plurality of parameters include at least a body part to be treated. In an embodiment, the plurality of parameters include at least a body part to be treated and condition to be treated.

### BRIEF DESCRIPTION OF THE DRAWINGS

FIG. 1 is a diagram of architecture for implementing a service provider client service consultation and management system (SPSMS) according to various embodiments.

FIG. 2A is an illustration of a SPSMS service provider login interface according to various embodiments.

FIG. 2B is an illustration of a SPSMS service provider interface for reviewing services and selecting to add a service (treatments in one embodiment) according to various embodiments.

FIG. 2C is an illustration of a SPSMS service provider interface for adding a service according to various embodiments.

FIG. 2D is an illustration of a SPSMS service provider interface for reviewing a newly added service including video(s) about service according to various embodiments.

FIG. 2E is an illustration of a SPSMS service provider interface for reviewing a previously added service including video(s) about service according to various embodiments.

FIG. 2F is an illustration of a SPSMS service provider interface for managing clients and services according to various embodiments.

FIG. 2G is an illustration of a SPSMS service provider interface for a client including details about their use of SPSMS according to various embodiments.

FIG. 2H is an illustration of a SPSMS service provider interface for inviting a client to use the SPSMS according to various embodiments.

FIG. 3A is an illustration of a SPSMS initial client interface according to various embodiments.

FIGS. 3B-3D are illustrations of a SPSMS client interface for selecting parameters/attributes to determine applicable/matching services according to various embodiments.

FIG. 3E is an illustration of a SPSMS client interface showing applicable/matching services including videos about the service according to various embodiments.

FIG. 3F is an illustration of a SPSMS client interface showing more details about a selected service including videos according to various embodiments.

FIG. 3G is an illustration of a SPSMS client interface showing saved/favorites services including videos about the service according to various embodiments.

FIGS. 4A and 4B are flow diagrams for algorithms according to various embodiments.

FIG. 5 is a data processing system according to various embodiments.

### DETAILED DESCRIPTION

Service providers may offer a variety of services to their clients. As part of the process of offering services, a provider may be required or desire to provide the client with a list of their services and the risks and benefits of their various services. A service provider may provide a client with descriptions of risks and benefits during a meeting or intake process with the client. Such meetings and intakes take a service providers limited time, and the client may not engage such services after learning the risks, benefits, and costs associated with one or more service offering of the provider. The service provider may be a legal, medical, or other trade professional in an embodiment.

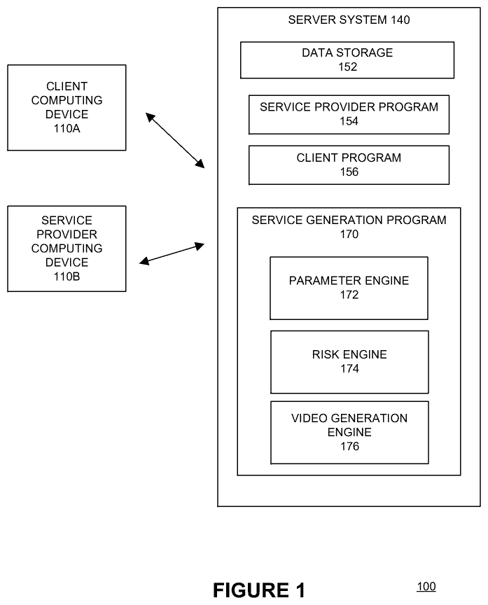

FIG. 1 is a diagram of architecture 100 for implementing a service provider client service consultation and management system (SPSMS) according to various embodiments. As shown in FIG. 1, a SPSMS may include a server system 140 that communicates with clients' (or perspective clients) computing devices (CCD) 110A and service provider computer devices (SPCD) 110B. As shown in FIG. 1, the service system 140 may include data storage 152, a service provider program 154, a client program 156, and a service generation program 170. The service generation program 170 may include a parameter engine 172, a risk engine 174, and a video generation engine 176 in an embodiment.

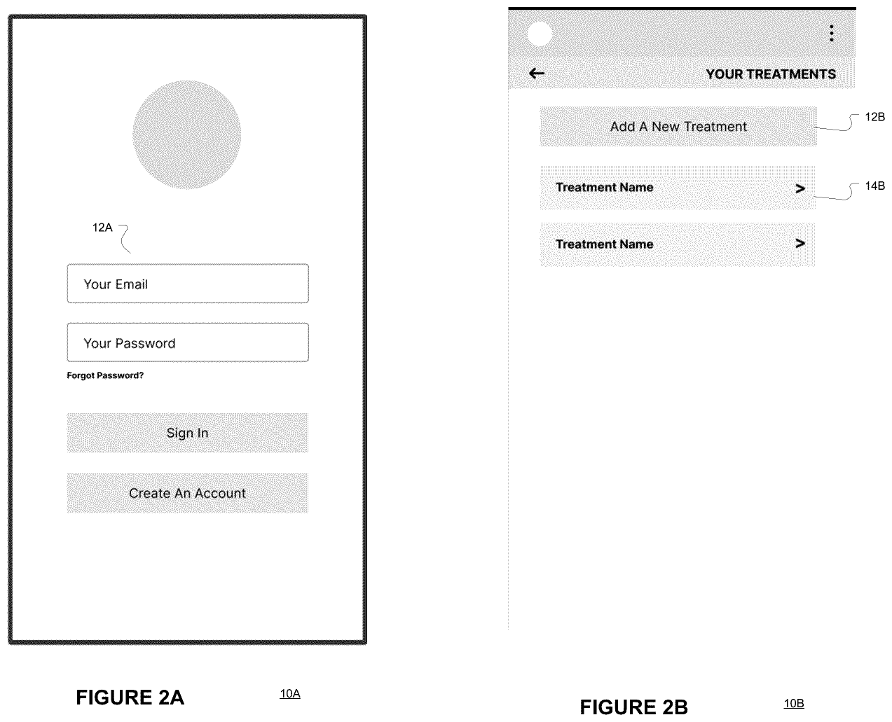

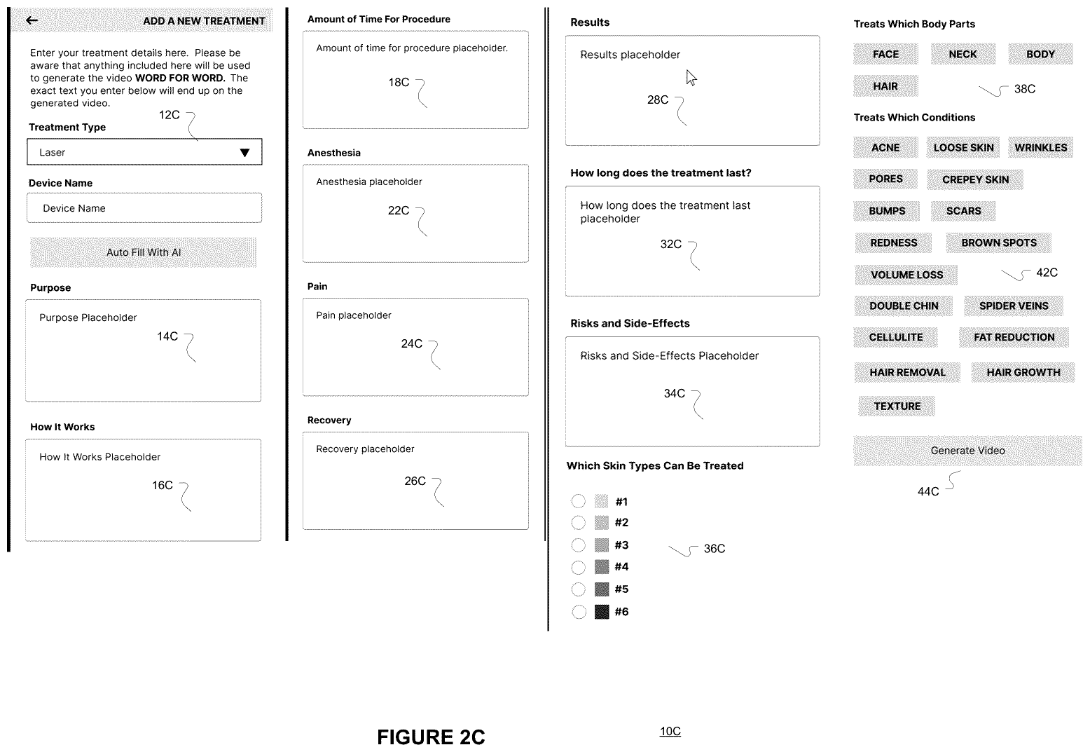

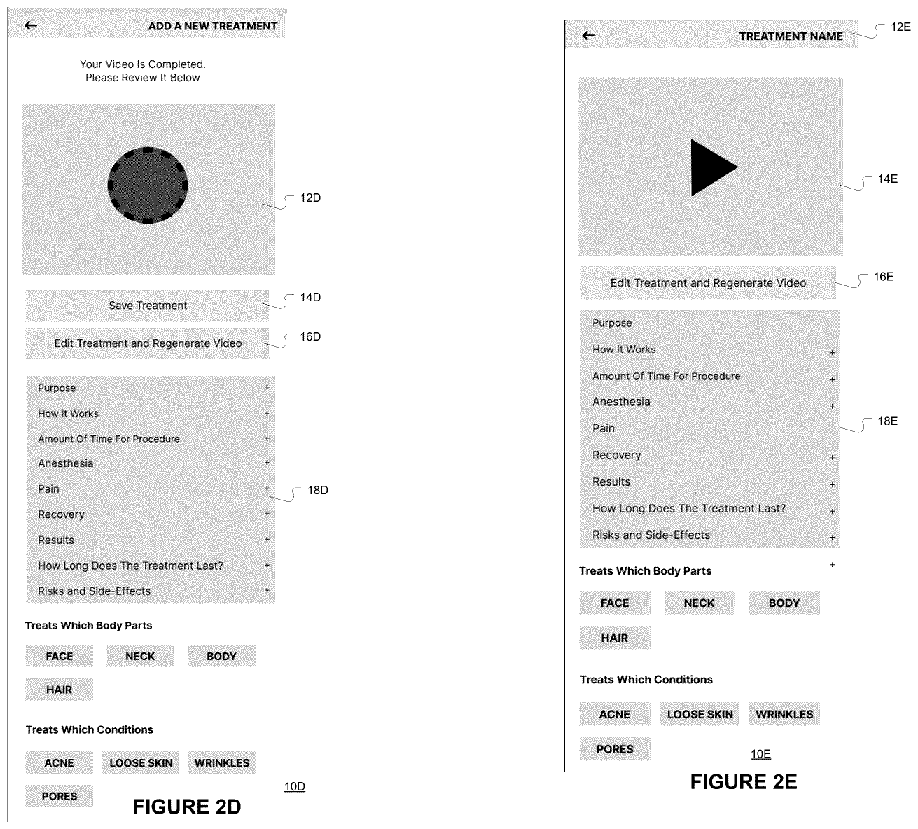

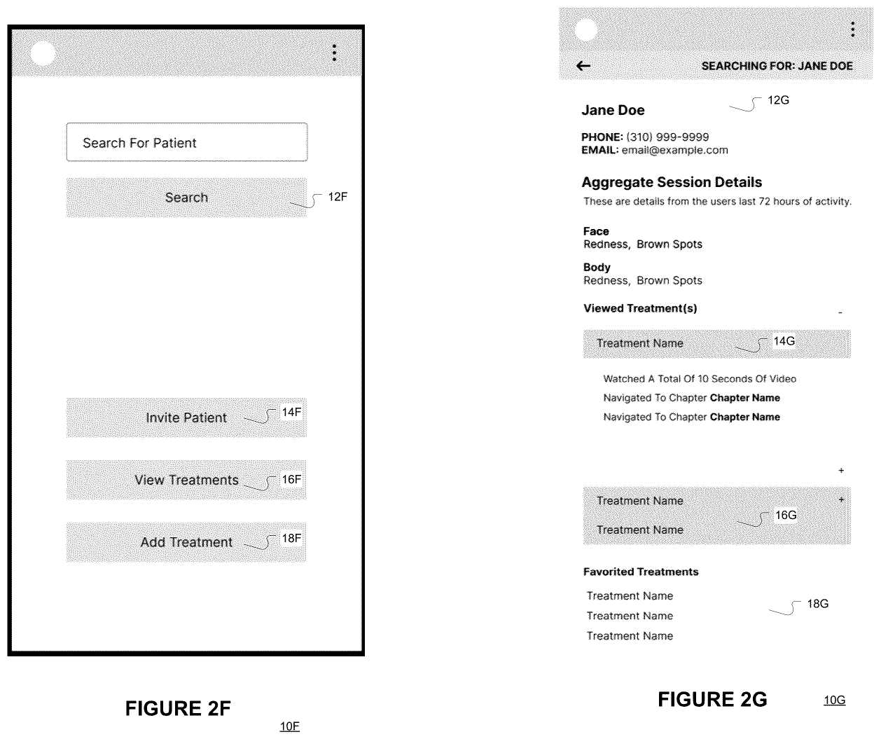

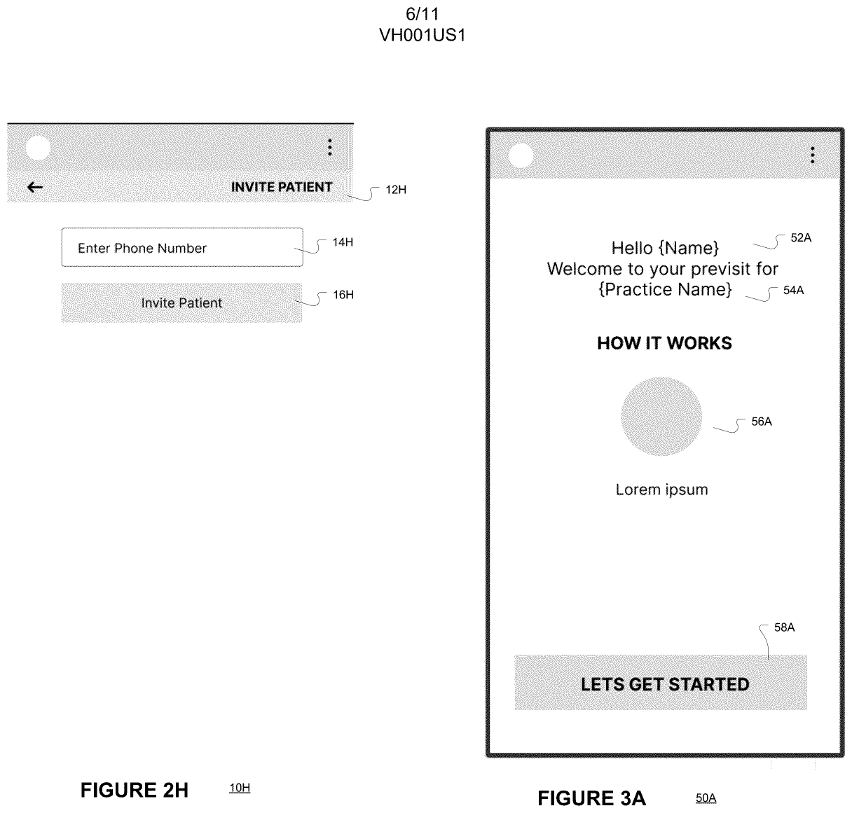

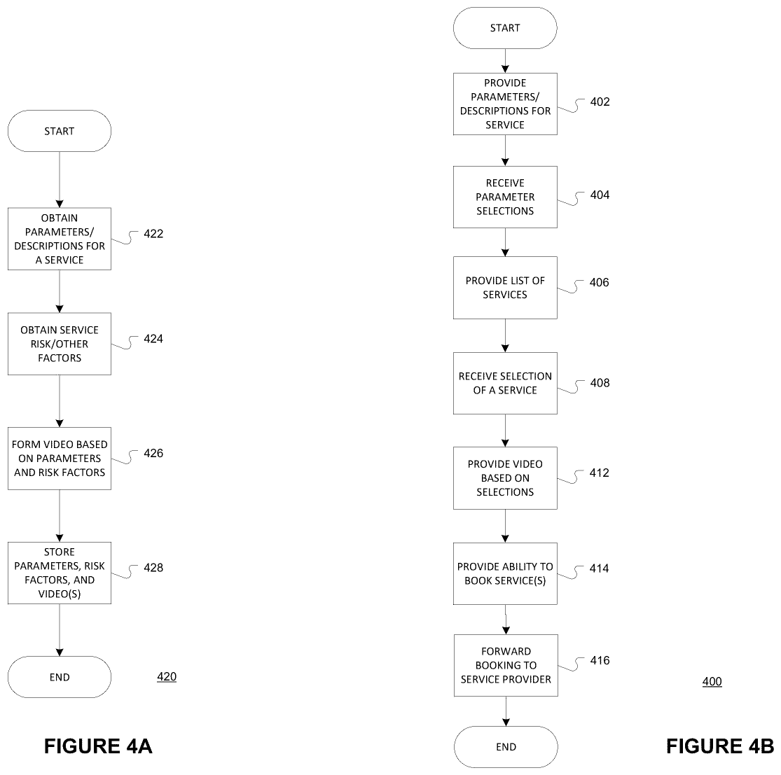

As described in more detail with reference to FIGS. 2A-2H and 4A, a service provider via a SPCD 110B may create or modify one or more services it provides and associated parameters via the server system 140 service provider program 154. A service provider via a SPCD 110B may invite clients and manage clients via the server system 140 service provider program 154.

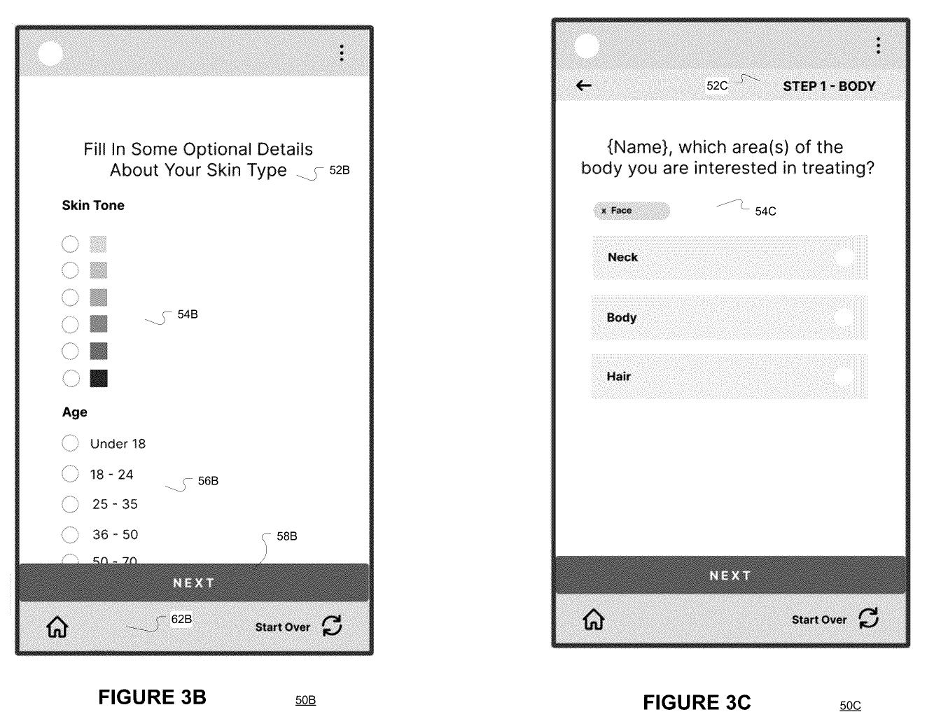

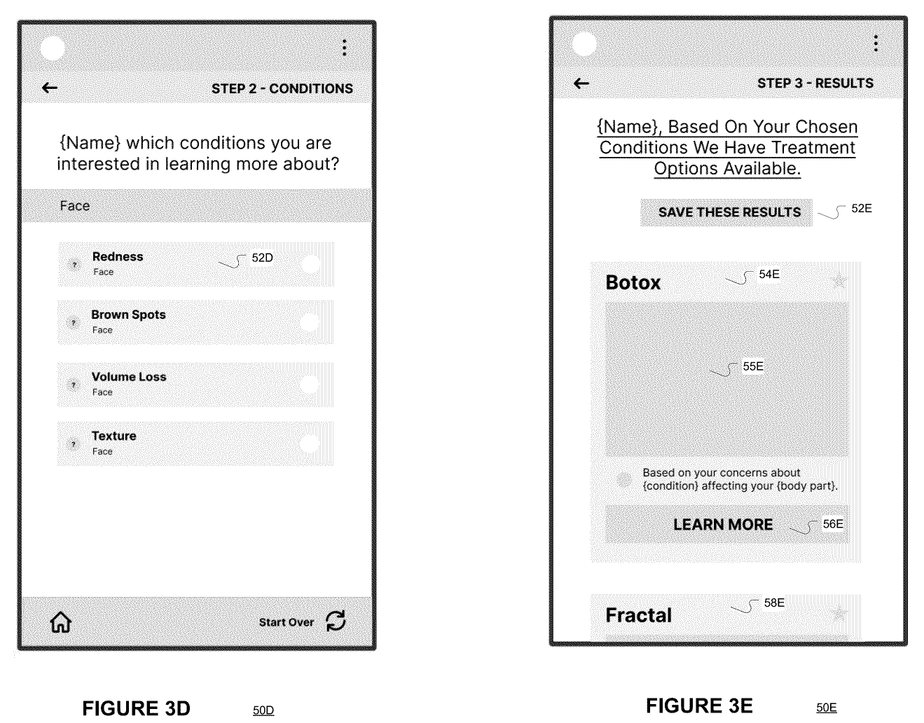

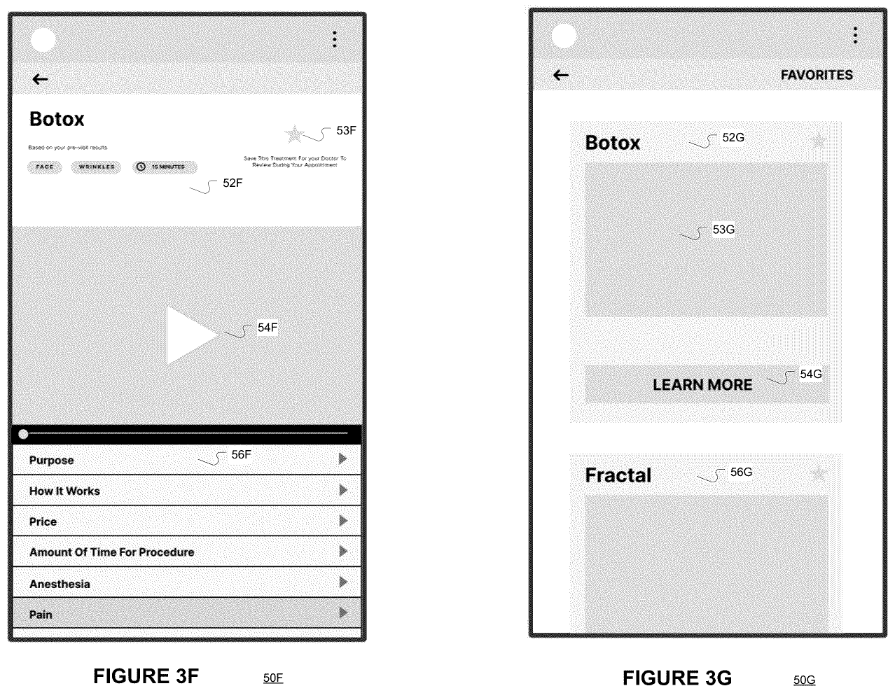

As described in more detail with reference to FIGS. 3A-3G and 4B, a client or potential client (herein after client) via a CCD 110A may review one or more services including videos about the services and its benefits/risks based on responses to parameters associated with the services via the server system 140 client program 156. FIG. 2A is an illustration of a SPSMS service provider login interface 10A according to various embodiments. The service provider program 154 may provide this interface 10A for existing or new service providers using architecture 100 to present their services to clients. As shown in FIG. 2A, a service provider may log into/create an account on the server system 140 via an email and password combination 12A, token, username, biometric data, or another information that may uniquely identify or confirm a service provider in an embodiment.

FIG. 2B is an illustration of a SPSMS service provider interface 10B for reviewing existing services 14B created via server system 140 and selecting to add a service 12B according to various embodiments. For illustration purposes, the service provider is a medical professional, in particular a dermatologist that may offer one or more services/procedures based on parameters associated or treatable by a service/procedure. The same service and parameter association may be employed for other service providers. When a service provider via SPCD 110B elects to add a new service (treatment/procedure in an embodiment) 12B, the server system 140 may employ the service generation program 170 to perform algorithm 420 shown in FIG. 4A to provide a service provider via SPCD 110B, the add service interface 10C shown in FIG. 2C.

In algorithm 420, a first activity 422 performed by the parameter engine 172 may include obtaining parameters (36C, 38C, 42C-FIG. 2C) and description 14C for a service 12C to be added. In an embodiment, the server system 140 may have certain presets for service type 12C and parameters 36C, 38C, 42C that a service provider may select (by a pull-down list and selection/toggle of parameters). In an embodiment, a service provider via a SPCD 110B may be able to add service type 12C and one or more parameters 36C, 38C, 42C to be selected or toggled. In a further embodiment, service types 12C and one or more parameters may be provided for selection based on past services added by a service provider.

A SPCD 110B via risk engine 174, activity 424 may provide risk factors and other information about the service as shown in FIG. 2C. As shown in FIG. 2C, the other information and risk factors may include how the service works 16C, amount of time required for the service 18C, whether certain elements are required including anesthesia 22C, pain associated with the service/procedure 24C, recovery time for the service 26C, the potential results 28C, length of time required for the service (treatment) 32C, and the possible risks and side-effects for the service 34C.

A SPCD 110B via video generation engine 176, activity 426 may form/generate a video based on the risk factors and other information about the service as shown in FIG. 2C. In an embodiment, the video generation engine 176 may employ artificial intelligence (AI) to generate a video with AI generated actors based on the risk factors and other information and the service. In an embodiment, the video generation engine 176 may work with another server or 3^{rd} party application to generate a video based on the risk factors and other information and the service. Once the video is generated it may be presented along with other details of the service to be added in an interface 10D shown in FIG. 2D. As shown in FIG. 2D, a SPCD 110B may be able view the completed video 12D, save the new service/treatment 14D, edit the service to regenerate a new video 16D, and view details of the service 18D.

Similarly, a service provider via a SPCD 110B may be able to review and update a previously create service via the interface 10E of FIG. 2E. As shown in FIG. 2E, a service provider may be able to view the current video for the service 14E, review and modify attributes of the service 18E including risk factors, other factors, and parameters and regenerate the video 16E. In an embodiment selecting edit treatment and regenerate video 16E may invoke interface 10C of FIG. 2C where the previous entries for the exiting service will be shown and be updatable.

The server system 140 service provider program 154 may also enable a service provider to manage existing clients and invite potential clients to review the services they created previously based selected parameters. In an embodiment, a server system 140 may provide the interface 10F shown in FIG. 2F to enable a service provide to manage clients and services according to various embodiments. As shown in FIG. 2F, a service provider may be able to search for an existing client 12F, invite new clients 14F, view existing services/treatments 16F, and add new services/treatments 18F. As shown in FIG. 2H, an invite client interface 10H may enable a service provider to invite a client (patient in an embodiment) 12H via a contact 14H for the client including a phone number, email address, or other unique identifier, and then send an invitation to the client 16H.

In an embodiment, a server system 140 may provide the interface 10G shown in FIG. 2G to provide information about a client. As shown in FIG. 2G, the interface 10G may display details about the client 12G, metadata 14G about services reviewed using architecture 100 including amount of time a video was viewed, which sections or chapters of the video has been reviewed, and other viewing data for all services 16G reviewed. The client details interface 10G may also indicate one or more services that the client as annotated as favorites 18G in an embodiment as shown in FIG. 3G.

As shown in FIG. 2H, an invite client interface 10H may enable a service provider to invite a client (patient in an embodiment) 12H via a contact 14H for the client including a phone number, email address, or other unique identifier, and then send an invitation to the client 16H. FIG. 3A is an illustration of a SPSMS initial client interface 50A that a client may review via a CCD 110A in response to an invitation to architecture 100 according to various embodiments. As shown in FIG. 3A, the initial client interface 50A may include information about the client 52A, the service provider 54A, image of service provider 56A, and toggle 58A to start service assessment process (algorithm 400 shown in FIG. 4B and interfaces 50B-50D shown in FIGS. 3B-3D) where a client selects parameters related to potential services (activities 402, 404) provided by server system 140 client program 156 using algorithm 400.

FIGS. 3B-3D are illustrations of a SPSMS client interfaces 50B-50D for selecting parameters/attributes to determine applicable/matching services according to various embodiments. As shown in FIG. 3B, a client via a CCD 110A may provide/select parameters 52B for potential services (to be correlated thereto). For example, for a client seeking services from a dermatologist, the client may provide details about skin tone 54B and age 56B. Via the interface 50B, a client may return to a starting page 62B and select to provide more parameters (which may vary as function of the services to be potentially provided by a service provider). As shown in FIG. 3C via interface 50C, a client may also select body 52C regions 54C to receive service (treatment). A client may also select one or more conditions they are seeking to treat 52D via interface 50D of FIG. 3D. In an embodiment, the server system 140 client program 156 may use algorithm 400 in activity 406 may provide a list of services. The server system 140 client program 156 may correlate one or more services based on the client's parameter selection and the service providers listing of parameters associated with each service. The services and related parameters may be stored in data storage 152.

In an embodiment, services to be presented to client may be ordered based on the number of parameters that match parameters for the services as annotated by service provider during the creation/editing of the service (activity 406 of algorithm 400). FIG. 3E is an illustration of a SPSMS client interface 50E showing applicable/matching services including videos about the services according to various embodiments. As shown in FIG. 3E, the results/related services interface 50E includes an option to save the results 52E for future review and one or more services 54E, 58E most related to the parameters annotated by a client via CCD 110A. As also shown in FIG. 3E, a client via CCD 110A may view videos 55E about a service 54E. A client may also select to learn more about a particular service 58E via interface 50F shown in FIG. 3F (activity 408 of algorithm 400).

As shown in FIG. 3F, the detail service interface 50F includes list of parameters that were associated with the service, ability to save service as a favorite 53F, ability to view video(s) 54F (activity 412 of algorithm 400) about the service, and view other details including risks about the procedure. A client may also be able to book a service with service provider (activity 414). The server system 140 may forward the service request from a client to their SPCD 110B (activity 416) in an embodiment.

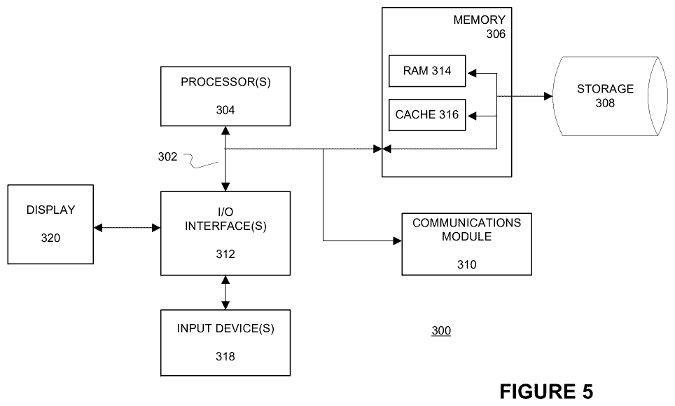

FIG. 5 depicts a block diagram of components of computing device 300 that may be employed as a computer device 110A, 110B or system 140 in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Computing device 300 may include a communications bus 302, which provides communications between computer processor(s) 304, memory 306, persistent or non-volatile storage 308, communications module 310, and input/output (I/O) interface(s) 312. Communications bus 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and storage 308 may be computer readable storage media. In this embodiment, memory 306 may include random access memory (RAM) 314 and cache memory 316. In an embodiment, memory 306 may include any suitable volatile or non-volatile computer readable storage media.

In an embodiment, service provider and client data may be stored in storage 308 for execution and/or access by one or more of the respective computer processors 304 via one or more memories of memory 306. In an embodiment, storage 308 may include a magnetic hard disk drive or a solid-state drive, a semiconductor storage device, read-only memory (ROM), erasable programmable read-only memory (EPROM), flash memory, or any other computer readable storage media that is capable of storing program instructions or digital information.

In an embodiment, media used by storage 308 may also be removable. For example, a removable hard drive may be used for storage 308. Other examples include optical and magnetic disks, thumb drives, and smart cards that are inserted into a drive for transfer onto another computer readable storage medium that is also part of storage 308.

Communications module 310 may provide communications with other data processing systems or devices, including computer device 110A, 110B or system 140. In an embodiment, communications module 310 may include one or more network interface cards including cellular or satellite interfaces. Communications module 310 may provide communications through the use of either or both physical and wireless communications links. Service provider and client data may be communicated to storage 308 through communications module 310.

I/O interface(s) 312 may allow for input and output of data with other devices that may be connected to or part of the computing device 300. For example, I/O interface 312 may provide a connection to an input device such as a keyboard, keypad, touch screen, video camera/lens, and/or some other suitable input device. Input devices 318 can also include portable computer readable storage media such as, for example, thumb drives, portable optical or magnetic disks, and memory cards. Software and data used to practice embodiments of the present invention, e.g., service provider program 154, client program 156, and the service generation program 170 may be stored on such portable computer readable storage media and can be loaded onto storage 308 via I/O interface(s) 312. I/O interface(s) 312 may also connect to a display or user perceptive module 320 in an embodiment.

The user perceptible module 320 may provide a mechanism to communicate data to a user and may be, for example, a computer monitor or an incorporated display screen, such as is used in tablet computers and smartphones, audio speaker, heads up display (HUD), virtual reality system, or other user perceptible mechanism capable of communicating data. The SPCD 110B and CCD 110A may be any electronic device capable of communicating with server 140 via any interface (wired, wireless, for combination thereof) including desktops, laptops, cellphones, tablets, smartwatches, for example only.

The programs described herein are identified based upon the application for which they are implemented in a specific embodiment of the invention. However, it should be appreciated that any particular program nomenclature herein is used merely for convenience and thus, the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network (LAN), a wide area network (WAN), and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flow illustrations and/or block diagrams of methods, apparatus (systems), and computer program products according to embodiments of the invention. It will be understood that each block of the flowchart illustrations and/or block diagrams, and combinations of blocks in the flow illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flow diagrams and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flow diagram and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flow diagrams and/or block diagram block or blocks.

The data flows or flow diagrams and block diagrams in the figures illustrate the architecture, functionality, and operation of possible implementations of systems, methods, and computer program products according to various embodiments of the present invention. In this regard, each block in the flowchart or flow diagrams, or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus, the following claims are hereby incorporated into the Detailed Description, with each claim standing on its own as a separate embodiment.

What is claimed is:

1. A computer-implemented service provider client consultation and management method comprising:
enabling a service provider to create a plurality of services, including;
obtaining a plurality of parameters for each service of the plurality of services;
obtaining at least one risk factor for each service of the plurality of services;
forming a video based on the plurality of parameters and at the least one risk factor for each service of the plurality of services;
storing the plurality of parameters, at least one risk factor, and formed video for each service of the plurality of services in a service database;
enabling a client to be presented with at least one service of the plurality of services, including:
providing a plurality of selectable parameters based on at least two of the plurality of services;
receiving at least one selection of the plurality of selectable parameters;
providing at least one selectable service including associated at the least one risk factor of the plurality of services based on the received at least one selection of the plurality of selectable parameters;
receiving at least one selection of the plurality services; and
providing the video associated with received at least one selection of the plurality services.

2. The computer-implemented method of claim 1, including forming a video based on the plurality of parameters and at the least one risk factor for each service of the plurality of services via artificial intelligence.

3. The computer-implemented method of claim 1, including forming a video based on the plurality of parameters and at the least one risk factor for each service of the plurality of services via artificial intelligence (AI) where the video includes at least one AI generated actor that describes each service based on its plurality of parameters and at least one risk factor.

4. The computer-implemented method of claim 3, further including enabling the service provider to view the AI generated video and elect to have the video regenerated by AI based on the plurality of parameters and at the least one risk factor for each service of the plurality of services.

5. The computer-implemented method of claim 1, including obtaining a plurality of parameters and at least one description for each service of the plurality of services and forming a video based on the plurality of parameters, the at one least description, and at the least one risk factor for each service of the plurality of services via artificial intelligence.

6. The computer-implemented method of claim 1, including obtaining a plurality of parameters and at least one description for each service of the plurality of services and forming a video based on the plurality of parameters, the at least one description, and at the least one risk factor for each service of the plurality of services via artificial intelligence (AI) where the video includes at least one AI generated actor that describes each service based on its plurality of parameters, at least one description and at least one risk factor.

7. The computer-implemented method of claim 1, including obtaining a plurality of parameters, at least one description, at least one risk factor, and at least one other factor for each service of the plurality of services and forming a video based on the plurality of parameters, the at least one description, the at least one risk factor, and the at least one other factor for each service of the plurality of services via artificial intelligence.

8. The computer-implemented method of claim 1, including obtaining a plurality of parameters, at least one description, at least one risk factor, and at least one other factor for each service of the plurality of services and forming a video based on the plurality of parameters, the at least one description, the at least one risk factor, and the at least one other factor for each service of the plurality of services via artificial intelligence (AI) where the video includes at least one AI generated actor that describes each service based on its plurality of parameters, at least one description and at least one risk factor.

9. The computer-implemented method of claim 1, further including enabling a client the ability to schedule the at least one selection of the plurality services.

10. The computer-implemented method of claim 1, further including enabling a client the ability to schedule the at least one selection of the plurality services after the client has been provided with the video associated with received at least one selection of the plurality services.

11. The computer-implemented method of claim 1, further including enabling a client the ability to schedule the at least one selection of the plurality services after the client has reviewed the video associated with received at least one selection of the plurality services.

12. The computer-implemented method of claim 1, further including enabling a client the ability to schedule the at least one selection of the plurality services after the client has reviewed the entire video associated with received at least one selection of the plurality services.

13. The computer-implemented method of claim 9, further including forwarding a notice to a service provider when a client schedules the at least one selection of the plurality services.

14. The computer-implemented method of claim 1, wherein the service provider is a medical provider and the client is one of a patient and a potential patient.

15. The computer-implemented method of claim 14, wherein the plurality of services is a plurality of medical treatments.

16. The computer-implemented method of claim 7, wherein the service provider is a medical provider and the client is one of a patient and a potential patient.

17. The computer-implemented method of claim 16, wherein the plurality of services is a plurality of medical treatments.

18. The computer-implemented method of claim 14, wherein the service provider is a dermatologist.

19. The computer-implemented method of claim 18, wherein the plurality of parameters include at least a body part to be treated.

20. The computer-implemented method of claim 19, wherein the plurality of parameters include at least a body part to be treated and condition to be treated.
